(19) United States
(12) Patent Application Publication
(10) Pub. No.: US 2014/0368634 A1
(43) Pub. Date: Dec. 18, 2014

(54) DEVICE FOR ANALYZING VISIBLE DEFECTS IN A TRANSPARENT SUBSTRATE

(71) Applicant: SAINT-GOBAIN GLASS FRANCE, Courbevoie (FR)

(72) Inventors: Michel Pichon, Gouvieux (FR); Franc Davenne, Thourotte (FR); Arnaud Cereyron, Margny Les Compiegne (FR)

(73) Assignee: SAINT-GOBAIN GLASS FRANCE, Courbevoie (FR)

(21) Appl. No.: 14/370,568

(22) PCT Filed: Nov. 28, 2012
(86) PCT No.: PCT/FR2012/052740

§ 371 Date: Jul. 3, 2014

(30) Foreign Application Priority Data
Dec. 2, 2011 (FR) 11 61114

(51) Int. Cl. G01N 21/958; H04N 5/235

(52) U.S. Cl. CPC G01N 21/958; H04N 5/2354
USPC 348/86

(57) ABSTRACT

The invention relates to a device (1) for analyzing the optical quality of one or more at least partially transparent substrates (2), for example a glass ribbon, run past the device (1), comprising:
an illuminating system (4, 6) for forming an image in transmission through the substrate (2) and/or in reflection from the substrate (2);
a camera (12) for acquiring the image transmitted and/or reflected by the one or more substrates (2); and
a control unit (14) comprising a memory (15) in which programs for controlling the acquisition of the images by the camera (12) are stored, in which:
the illuminating system (4, 6) can simultaneously produce illumination of different types in separate illumination zones (8A, 8B, 8C, 10A, 10B, 10C) through which the or each substrate (2) is intended to run;
the camera (12) is a matrix camera and can acquire an image with a plurality of rows of pixels, the device (1) being configured such that the camera (12) can simultaneously acquire images with a plurality of groups of adjacent rows of pixels, corresponding, respectively, to said separate zones (8A, 8B, 8C, 10A, 10B, 10C); and
said control programs are able to control the camera (12) so that the various acquisitions are synchronized with the run speed of the one or more substrates (2) such that at least one given fixed point on the substrate (2) is the subject of an image acquired by a first of said groups of rows of pixels and, at least, of an image acquired by a second group that is different from the first.

The invention relates to an analysis device ensuring detection, measurement and identification of point defects on the surface or in the bulk of a transparent substrate, i.e. an at least partially transparent substrate.

This device relates to any transparent product containing point defects that alter the appearance of the product with respect to its user. In particular, this device is suitable for detecting visible defects in glazing panes, whatever their intended use.

The detection of visible defects, their measurement (i.e. estimation of their severity) and their identification plays an essential role in glazing pane quality control.

The simple detection of these visible defects, often associated with an estimation of their size, is, at the present time, no longer sufficient to ensure effective quality control. The data characterizing the detected defects must also be supplemented with a defect severity level, estimated on different scales depending on the nature of the defect, and their identification.

Defect characterization must most often be carried out on a substrate moving along a production line and exhaustively, i.e. 100% of products must be controlled. Furthermore, this control must preferably take place during production of the base product since detection of visible defects in the finished product (automotive glazing unit, double glazing unit, etc.) would require rejection of an expensive, processed product.

Identification of defects is the most complex challenge on account of the speed of travel of the substrate during an in-line control, of the small size of the defects (often millimeter-sized) and of the presence of “false” defects that must be ignored by the detecting device. In addition, the nature of the defect contributes to the definition of its severity. For the sake of the quality of this identification, as much data as possible regarding the optical and dimensional properties of the defect must be obtained.

This is the reason why current control systems use a plurality of detection channels—typically formed by an illumination associated with one or more cameras—in order to obtain, for a given defect, a plurality of characteristic responses that will be combined in order to attempt to identify the nature of the visible defect detected.

Visible defects are often point defects located on the (upper or lower) surface or in the bulk of the substrate.

Visible defects are commonly characterized using a classification based on their physical characteristics (bubbles, solid mineral inclusions, scratches, solid metal inclusions, etc.).

This classification, although it has the merit of being easily understood by the operators in charge of quality control, is unsuitable for optimization of a device for controlling this type of defect.

It indeed proves to be more beneficial to develop a classification based on the optical behavior of these defects with respect to a light source. It is then possible to class these defects depending on their optical properties i.e. depending on whether they absorb, scatter, bend, polarize or color, etc. incident light.

It is also possible to associate a sensitivity level with each of these defects, and with the optical properties of this classification, ranging, for example, from 0 to 1.

Thus a metallic inclusion will be classed among absorbing defects of sensitivity level 1 because this type of defect absorbs all the light incident thereon. Its other properties will have a level of 0 because this type of defect, a priori, neither scatters, nor deforms, nor polarizes, nor colors, etc. A scratch could be classed as absorbent with a low sensitivity and scattering with a high sensitivity, its sensitivity to other properties being zero. Gaseous inclusions are both absorbent and scattering with an average sensitivity and bend light at their periphery with a high sensitivity.

It will thus be understood that at least one optical property can be associated with each type of visible defect, the use of this at least one optical property allowing optimal detection of the defect.

It is also possible to associate, with each of the optical properties of this classification, the illumination type that will be most suitable for detecting the defects. Thus absorbent defects will be most clearly detected on a light luminous background (often called a bright field) and scattering defects will be most clearly exhibited using indirect illumination (often called a dark field). Bending defects will be most clearly visible under patterned illumination, etc.

These illumination modes can be implemented in transmission (source and detector placed on either side of the substrate) or in reflection (source and detector on the same side of the substrate).

It will thus be understood that since all the defects are not equally sensitive to the various optical properties of this classification, the detection quality will depend on the illumination type employed. The use of a single illumination type will allow detection of certain defects and prevent that of others. Effective detection of visible defects therefore requires the use of a plurality of different types of illumination, in transmission and/or in reflection.

By increasing the number of illuminations used it is possible to obtain differentiated responses for each defect detected. By multiplying and combining the optical responses obtained for a given defect using different illuminations, the capacity of the system to not only detect the defects, but also the identify them, is improved.

WO-A-2007/045437 describes a system of this type.

Since this solution incorporates a plurality of illuminations, although it has advantages in terms of effectiveness, it proves to be more complicated and expensive to implement. Specifically, control of running products is still ensured by one or more linear cameras that observe the illumination with which they are associated, in transmission or in reflection, over the entire width of the product to be inspected. A plurality of measurement channels, i.e. a plurality of different illuminating systems associated with a plurality of sets of linear cameras, may be installed in parallel. However, this type of architecture has the following drawbacks:
it is only rarely possible to install more than three illuminating systems (typically two in transmission and one in reflection);
the additional cost is practically proportional to the number of systems installed;
its bulk is increased; and
its complexity is increased and its reliability decreased.

Discontinuous control (control in which the object to be controlled is stopped) necessarily uses a matrix camera, and does not permit the use of a plurality of different types of illumination. In addition, it is very slow and not suitable for exhaustive quality control.

It will be recalled that a linear camera comprises a sensor formed from a single row of pixels. A matrix camera is composed of a sensor formed from a matrix of pixels.

Several detecting devices are available on the market.

For example, the ScreenScan-Final system sold by ISRA Vision is intended for the control of visible defects on automotive glazing unit production lines.

This device is equipped with a plurality of light sources that are observed in reflection and in transmission, each of the light sources being associated with a series of linear cameras. This device, which has three measurement channels, is expensive, complex, bulky and can only control an automotive glazing unit about once every 20 seconds. It is not suitable for controlling a continuously running glass ribbon.

The Smartview Glass system sold by the American company Cognex is designed to detect and identify defects on a float-glass production line.

This machine, which may be provided with a plurality of illuminations, detects and (partially) identifies visible defects in the glass. In a float-glass production line, this system typically makes use of a set of five linear cameras in order to cover the entire width of the glass ribbon. Defect severity is defined only in terms of defect size.

US-A-2007/0263206 illustrates a device in which a substrate is simultaneously illuminated by a “dark field” and a “bright field”.

Nevertheless, in this system there is interference between each field, which leads to difficulties with defect detection and categorization.

As for patent application WO-A-2010/130226, by the Applicant, it describes a device using various illuminations that illuminate the running glazing pane in alternation.

One aim of the invention is to provide a simple and inexpensive device allowing detection, measurement (in terms of severity) and identification of point defects in a continuously running transparent substrate with a good performance level.

One subject of the invention is a device for analyzing the optical quality of one or more at least partially transparent substrates, for example a glass ribbon, run past the device, comprising:
an illuminating system for forming an image in transmission through the substrate and/or in reflection from the substrate;
a camera for acquiring the image transmitted and/or reflected by the one or more substrates; and
a control unit comprising a memory in which programs for controlling the acquisition of the images by the camera are stored, in which:
the illuminating system can simultaneously produce illumination of different types in separate illumination zones through which the or each substrate is intended to run;
the camera is a matrix camera and can acquire an image with a plurality of rows of pixels, the device being configured such that the camera can simultaneously acquire images with a plurality of groups of adjacent rows of pixels, corresponding, respectively, to said separate zones; and
said control programs are able to control the camera so that the various acquisitions are synchronized with the run speed of the one or more substrates such that at least one given fixed point on the substrate is the subject of an image acquired by a first of said groups of rows of pixels and, at least, of an image acquired by a second group that is different from the first.

With such a device, it is possible, simultaneously, to analyze all of a running ribbon of float glass with, for example, three different types of illumination in transmission and three different types of illumination in reflection, and using only one camera.

The use of multiple types of illumination means that it is possible to reliably analyze the number, size and type of defects at a reasonable cost and with a reasonable bulkiness.

According to particular embodiments, the device comprises one or more of the following features, whether separately or in any technically possible combination:
the synchronization is such that the entire length to be analyzed, of the one or more substrates, is analyzed with each of the various types of illumination;
for at least two types of illumination, the various groups of adjacent rows of pixels contain an identical number of rows;
at least one of the groups of adjacent rows of pixels contains at least 5 adjacent rows of pixels, for example at least 10, for example at least 50;
said groups of adjacent rows of pixels are arranged pairwise and contain at least 5 adjacent rows of pixels, for example at least 10, for example at least 50;
the device is configured so that at least a plurality of said various types of illumination of the separate zones are in transmission or so that at least a plurality of said various types of illumination of the separate zones are in reflection;
the device is configured so that at least one of said various types of illumination is in transmission through one of the separate zones and so that at least one of said various types of illumination is in reflection from another of the separate zones;
the device is configured so that a plurality of said various types of illumination of separate zones are in transmission through a plurality of separate zones and so that a plurality of said various types of illumination are in reflection from a plurality of other of the separate zones;
the illuminating system and the camera are, in operation, stationary relative to one another, and the one or more transparent substrates travel relative to the illuminating system and the camera;
the device comprises a unit for processing the images acquired by the camera, the processing unit including a computer and a memory in which processing programs are stored, which programs can be run by the computer, said programs being able to return quantities representative of the optical quality of the one or more substrates analyzed; and
at least one of the separate illumination zones, and preferably each illumination zone, has an oblong outline with a length/width ratio >10.

Another subject of the invention is a method for analyzing the optical quality of one or more at least partially transparent substrates, for example a glass ribbon, on the run, comprising:
an illuminating system for forming an image in transmission through the substrate and/or in reflection from the substrate;
acquiring the image transmitted and/or reflected by the one or more substrates via a camera; and
running programs controlling the acquisition of the images by the camera,
   in which:
the illuminating system simultaneously produces illumination of different types in separate illumination zones through which the one or more substrates run;
images are acquired simultaneously by a plurality of rows of pixels in a plurality of groups of adjacent rows of pixels, corresponding, respectively, to said separate illumination zones; and
the various acquisitions are synchronized with the run speed of the one or more substrates such that at least a given fixed point on the substrate is the subject of an image acquired by a first of said groups of rows of pixels and, at least, of an image acquired by a second group that is different from the first.

The present invention is now described using purely illustrative and in no way limiting examples of the scope of the invention, and with regard to the appended drawings, in which:

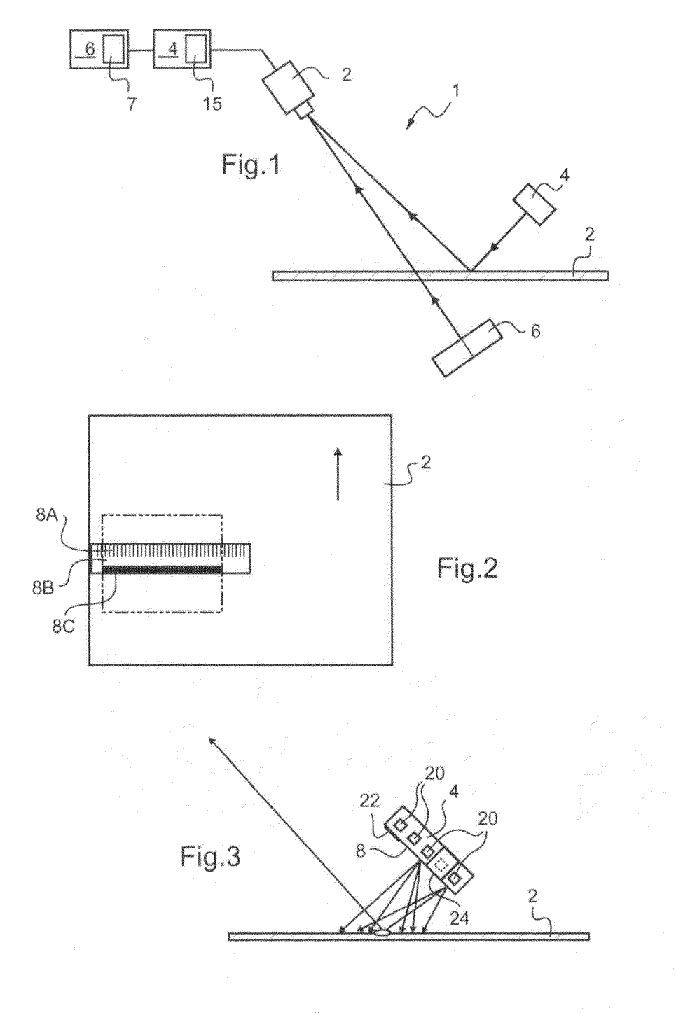

FIG. 1 shows a schematic cross-sectional view of an analysis device according to the invention with a matrix camera and two illuminating units, one illuminating in transmission, the other in reflection;

FIG. 2 shows a top view of a running glass ribbon, in which can be seen, in the region enclosed by dotted lines—corresponding to the field of the camera—three different illumination zones produced by an illuminating unit: a zone of patterned illumination (striped illumination in the figure), a directly illuminated bright field zone, and an indirectly illuminated dark field zone;

FIG. 3 is an analogous view to FIG. 1, illustrating in greater detail an illuminating unit suitable for producing the illumination zones shown in FIG. 2, in which a plurality of adjacent rows of LEDs are used to produce the illumination, a first row of LEDs being covered with a mask in order to produce patterned illumination, and a fourth row being “turned off” or covered with an opaque screen in order to produce a zone of indirect illumination on the running substrate by virtue of the illumination from the LEDs in adjacent rows;

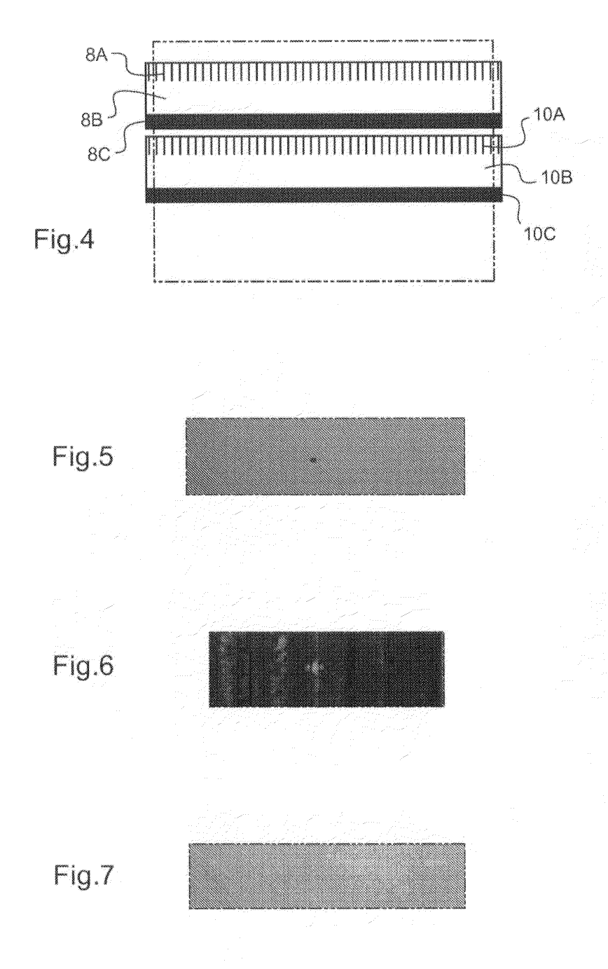

FIG. 4 shows a schematic view of an image captured by the matrix camera, illustrating the positioning of the various illuminations in the plane of the receiver of the camera in the case, for example, shown in FIG. 1 where two units are present and illuminate separate zones in first regions; and

FIGS. 5 to 12 illustrate various images returned by the device after acquisition and processing.

The figures are not to scale for the sake of legibility.

FIG. 1 illustrates a device 1 for analyzing point defects in a float-glass ribbon 2 (i.e. an at least partially transparent substrate) that is in continuous motion relative to the device 1. This device 1 comprises, on either side of the substrate 2, two illuminating units 4, 6, one illuminating in transmission and the other in reflection. Each unit 4, 6 simultaneously illuminates different zones 8A, 8B, 8C, 10A, 10B, 10C (FIGS. 2 and 4) called “illumination” zones, all of which are separate, and through which the substrate 2 runs.

As illustrated in FIGS. 1 to 4, these zones 8A, 8B, 8C, 10A, 10B, 10C correspond to subdivisions in the plane of travel of the ribbon 2.

The images formed on the substrate 2 by these two units 4, 6 are acquired by means of a single matrix camera 12. This camera is, in FIG. 1, placed on the same side as the unit 4 illuminating in reflection (i.e. on the side opposite the unit 6 illuminating in transmission).

The camera 12 is controlled by a control unit 14.

The images acquired by the camera 12 are then processed by a processing unit 16 in order to return values representative of the number, size and type of defects analyzed.

According to an essential aspect of the invention, the acquisition of the images by the camera 12 is carried out in such a way that the entire substrate 2 surface can be analyzed with all the illumination types.

To do this, the pixels of the camera 12 are divided into various groups of adjacent rows of pixels (transverse to the travel of the substrate 2). Each group is associated with a corresponding zone illuminated with a particular illumination type.

The acquisition is synchronized such that all of the substrate 2 is analyzed. In other words, if the groups consist of n adjacent rows with a resolution of Δx millimeters per row in the plane of a substrate moving at a speed v, the interval between acquisitions will be equal to n·Δx/v.

However, the groups do not necessarily contain the same number of rows of pixels, even though it is preferable if they do. Furthermore, the acquisition is not necessarily carried out so that the entire substrate 2 analyzed is covered (as illustrate by way of example in FIG. 2), even though it is also preferable if it is (i.e. by providing a camera field and illuminating sources of sufficient width).

More generally, the acquisition is therefore synchronized in such a way that at least one given fixed point on the substrate 2 is the subject of an image acquired by a first of said groups of rows of pixels and, at least, the subject of an image acquired by a second group that is different from the first.

Preferably, the entire area of the substrate 2 that it is desired to analyze is the subject of images acquired in succession using each of the groups of rows of pixels associated with the various illuminations 8A, 8B, 8C, 10A, 10B, 10C.

It will be noted that a number of features can be generalized.

Firstly, the camera 12 and the illuminations 8A, 8B, 8C, 10A, 10B, 100 can be placed for various image acquisitions, all corresponding to the substrate 2 seen in transmission, or all to the substrate 2 seen in reflection, or even all in reflection and in transmission. In this respect, there are no particular constraints. An analysis both in reflection and in transmission is preferred.

Generally, the illuminating system is configured such that the different (i.e. separate) zones 8A, 8B, 8C, 10A, 10B, 100 under which (i.e. “through” which) the substrate 2 runs are illuminated differently.

The expression “illumination of different types” is understood to mean illuminations under which the defects appear differently and require different processing or analysis.

The subject of the analysis (namely in the example of a glass ribbon) is, as a variant, a running succession of separate glass sheets or glazing units. In addition, the one or more substrates are not necessarily made of glass but may, for example, as a variant, be made of plastic.

The one or more substrates are generally at least partially transparent. Complete transparency is not required.

Thus, generally, one subject of the invention is a device 1 for analyzing the optical quality of one or more at least partially transparent substrates 2 that is/are continuously run past the device 1, for example a glass ribbon, comprising:
an illuminating system 4, 6 for forming an image in transmission through the substrate and/or in reflection from the substrate;
a camera 12 for acquiring the image transmitted and/or reflected by the one or more substrates 2; and
a control unit 14 comprising a memory 15 in which programs for controlling the acquisition of the images by the camera 12 are stored,
   in which:
the illuminating system 4, 6 simultaneously produces illumination of different types in separate illumination zones 8A, 8B, 8C, 10A, 10B, 10C through which the or each substrate 2 is intended to run;
the camera 12 is a matrix camera and can acquire an image with a plurality of rows of pixels (transverse to the motion of the one or more substrates (2),
   the device 1 being configured such that the camera 12 can simultaneously acquire images with a plurality of groups of adjacent rows of pixels, corresponding, respectively, to said separate zones 8A, 8B, 8C, 10A, 10B, 10C; and in which
   said control programs are able to control the camera so that the various acquisitions are synchronized with the run speed of the one or more substrates 2 such that at least one given fixed point on the substrate 2 is the subject of an image acquired by a first of said groups of rows of pixels and, at least, of an image acquired by a second group that is different from the first.

It will be noted that the expression “fixed point” is understood to mean a stationary point on the substrate 2 i.e. a point that does not move relative to the substrate 2.

It will be noted that it is not excluded that the device 1 comprises a plurality of cameras.

Advantageously, the separate illumination zones 8A, 8B, 8C, 10A, 10B, 10C have a very elongate oblong outline (i.e. with a length/width ratio >10) in the direction transverse to the direction of travel of the substrate analyzed, especially so as to reduce their bulk (i.e. as illustrated in FIGS. 2 and 4).

Even more advantageously, one of the illuminations consists of a series of longitudinal bars (parallel to the direction of travel) spaced apart transversely over the entire width of the substrate 2, as illustrated in FIG. 2, and as described in patent application WO-A-2011/121219 of the Applicant. Specifically, this pattern is particularly suitable and effective for partial acquisition with groups of rows of pixels, because it allows the images acquired to be easily concatenated.

By way of example, FIG. 2 illustrates various possible illuminations in the separate zones 8A, 8B, 8C.

These illuminations are produced by means of a single oblong unit 4; 6, in which light sources (e.g. LEDs) are used to illuminate the substrate 2 as it runs past so as to produce different illuminations in three different (i.e. separate) zones 8A, 8B, 8C.

The first illumination zone 8A is illuminated with a series of longitudinal bars, such as described above.

The second illumination zone 8B is illuminated directly with a bright field.

The third illumination zone 8C is illuminated indirectly with a dark field.

Generally however each illumination is of any suitable type. Even more generally, the illuminating system may be of any suitable type.

To produce such illuminations, the illuminating unit 4 (here in reflection in FIG. 3) comprises, for example, an oblong plate 18 made of a white scattering material, behind which a linear illuminating source 20 such as a fluorescent tube, or more advantageously light-emitting diodes (LEDs), is placed, which illuminating source illuminates the scattering plate 18 with sufficient brightness to ensure a satisfactory image is captured by the camera 12. In particular, the use of LEDs allows the brightness of this illumination to be modulated by varying the supply voltage across the terminals of the LEDs and/or by installing a plurality of rows of LEDs side-by-side, which LEDs are powered as required. The use of LEDs also allows colored light to be used, i.e. LEDs to be chosen that emit in a specific spectral band in order to optimize detection of color defects. Thus, easily and at a lower cost, a unit emitting diffuse light and generating an illumination that is bright and modulatable as required over a wide dynamic range, is obtained.

To produce the three illuminations described above, it is possible to add, to this scattering area, by screen-printing or another printing method, a regular pattern 22 consisting of a succession of alternate light and dark lines, placed parallel or perpendicular to the direction of travel of the substrate, so as to form the first illumination, called the patterned illumination.

The first illumination is dedicated to detecting bending defects, the second, a “bright field”, to detecting absorbent defects.

The third illumination is, for example, also obtained by screen- printing or printing using another method, on the same scattering panel 18, a second pattern 24 consisting of a black strip that, in association with the neighboring bright field, forms an indirect illumination (i.e. a dark field). Thus, a patterned illumination, a bright field illumination, and a dark field illumination are created side-by-side on the same substrate and in the same plane (FIGS. 2 and 3).

By way of example, an illuminating unit for a float-glass production line will, for example, measure 3500 mm by 200 mm.

This illuminating unit is for example used in transmission.

The optical field covered by a matrix camera is typically 700 mm by 500 mm. It is also possible to add a unit illuminating in reflection of the same size, slightly shifted in space in order not to be superposed, in this optical field, on the unit illuminating in transmission. This is what FIGS. 1 and 4 illustrate.

The matrix camera 12 then observes in its optical field the unit 4 illuminating in reflection and then the unit 6 illuminating in transmission, each illumination type occupying part of the field of the image acquired by the camera.

The illuminating unit 6 used in transmission is for example the same as that described above and illustrated in FIG. 2.

If the light levels of the illuminating units are not balanced (for example, high transmission through the substrate 2 and low reflection from the substrate 2) it is possible to balance these light levels by adjusting the number and brightness of the illuminating sources. This adjustment is particularly simple and automatable in the case where LED sources are used.

If it necessary to see clearly both the plane of the illuminating units and the surface of the substrate 2 containing the defects, the illuminating units will be placed sufficiently near the substrate, the light levels of the illuminating units will be increased, and the aperture of the objective will be judiciously chosen in order to provide a sufficient depth of field to meet these requirements.

The unit 6 illuminating in transmission, and that 4 illuminating in reflection, will be placed almost symmetrically about the running substrate 2 so that the same camera 12 will be able to see clearly the two illuminating units 4, 6.

The dimensions of one illuminating unit 4 may be tailored to the field of a single matrix camera 12, or else to cover the optical field corresponding to a plurality of matrix cameras 12 in the case where a very wide product is to be analyzed.

The camera 12 is connected to a unit 16 for processing the images acquired in order to allow the images to be processed if needs be, as is the case for images produced by patterned illumination and dark field illumination. Bright field illumination does not necessarily require computer processing and may be analyzed by eye.

The processing unit 16 includes a computer and a memory 17 in which processing programs able to be run by the computer are stored. The programs are able to return quantities representative of the optical quality of the one or more substrate 2 analyzed, based on the images acquired.

It is possible, either by sampling from the matrix camera 12 only those rows of the image associated with each illumination type, or by transferring the entire matrix image to the processing unit 16 and then extracting by software means the parts of the image associated with each illumination type, to obtain image portions corresponding to each illumination implemented. Next, the data corresponding to each illumination type can be processed separately in order to extract therefrom data on the response of the defect with respect to the illumination type, to estimate the severity of the defect, and to combine these data in order to identify the nature of the defect.

FIGS. 5 to 12 illustrate images returned by the device 1 for four different glass samples.

These images are a result of the concatenation of a number of groups of acquired lines. The bright field images correspond to the acquired images. The patterned images and dark field images underwent processing that employed a color code to express the results of calculations carried out on the acquired images, in a way known per se.

The first sample (FIGS. 5 and 6) was analyzed with bright field illumination in transmission (FIG. 5) and patterned illumination in transmission (FIG. 6), and shows the detection of an absorbent defect.

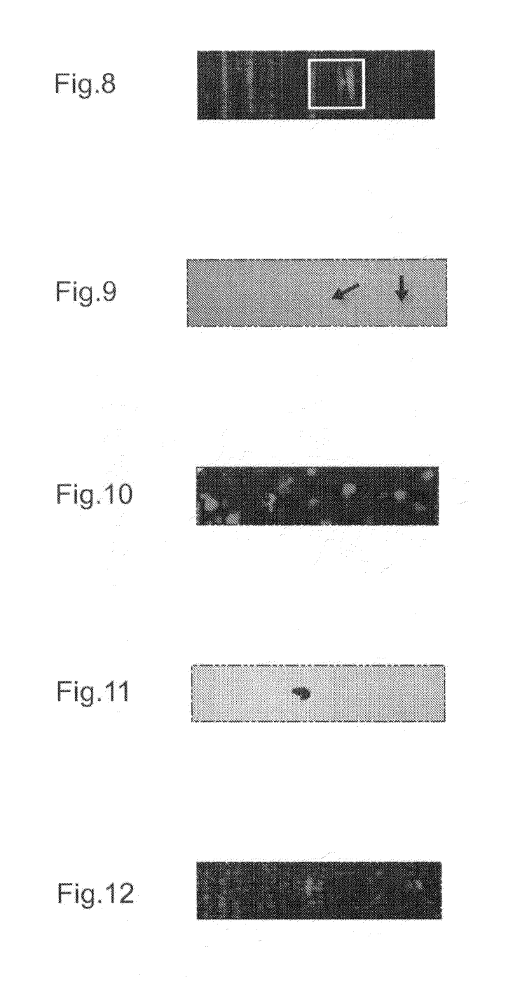

The second sample (FIGS. 7 and 8) contained a bending defect that was much more easily seen under patterned illumination (FIG. 8) than under bright field illumination (FIG. 7).

The third sample (FIGS. 9 and 10) had a scattering defect, visible in the dark field (FIG. 10) but hard to see in the bright field (FIG. 9), and the fourth (FIGS. 11 and 12) a metallic inclusion, particularly apparent with the bright field (FIG. 11) but not with a dark field illumination (FIG. 12).

With the invention, if the resolution of the camera 12 in the direction of travel is 0.5 mm per row of pixels, it is possible, for example, to acquire, with a single shot, a group of 100 adjacent lines, which corresponds to a length of 50 mm of the running substrate 2. The information contained in these 100 rows of pixels will then be transferred to a processing unit 16 while a new acquisition will be carried out for the following 50 mm of the substrate 2. Synchronizing the acquisition with the run speed of the substrate 2 makes it possible to observe the entire substrate 2 in the direction of travel, with a coverage error for the substrate 2 ideally of 0%.

If the synchronization is not perfect and there is an error of 0.1 mm, the coverage area for the substrate 2 would be 0.1/50 i.e. 0.2%, which is negligible.

Using a single detector 12 (the matrix camera) to observe all of the illuminations also has the advantage of making the system more tolerant to slight displacement of the camera 12 or illuminating units 4, 6, since these temporal shifts will remain constant and can therefore be compensated for. This helps make the analysis more reliable and lowers its cost.

1. A device for analyzing the optical quality of an at least partially transparent substrate, run past the device, comprising:
an illuminating system, which forms an image in transmission through the at least partially transparent substrate and/or in reflection from the at least partially transparent substrate;
a camera, which acquires the image transmitted and/or reflected by the at least partially transparent substrate; and
a control unit comprising a memory in which programs for controlling the acquisition of the images by the camera are stored, wherein:
the illuminating system simultaneously produces illumination of different types in separate illumination zones through which the at least partially transparent substrate is intended to run;
the camera is a matrix camera and acquires an image with a plurality of rows of pixels, the device being configured such that the camera simultaneously acquires images with a plurality of groups of adjacent rows of pixels, corresponding, respectively, to said separate zones; and
said control programs control the camera so that the various acquisitions are synchronized with the run speed of the at least partially transparent substrate such that at least one given fixed point on the at least partially transparent substrate is the subject of an image acquired by a first of said groups of rows of pixels and, at least, of an image acquired by a second group that is different from the first.

2. The device of claim 1, wherein the synchronization is such that the entire length to be analyzed, of the at least partially transparent substrate, is analyzed with each of the various types of illumination.

3. The device of claim 1, wherein, for at least two types of illumination, the various groups of adjacent rows of pixels contain an identical number of rows.

4. The device of claim 1, wherein at least one of the groups of adjacent rows of pixels contains at least 5 adjacent rows of pixels.

5. The device of claim 1, wherein said groups of adjacent rows of pixels are arranged pairwise and contain at least 5 adjacent rows of pixels.

6. The device of claim 1, wherein the device is configured so that at least a plurality of said various types of illumination of the separate zones are in transmission or so that at least a plurality of said various types of illumination of the separate zones are in reflection.

7. The device of claim 1, wherein the device is configured so that at least one of said various types of illumination is in transmission through one of the separate zones and so that at least one of said various types of illumination is in reflection from another of the separate zones.

8. The device of claim 6, wherein
wherein the device (1) is configured so that at least one of said various types of illumination is in transmission through one of the separate zones and so that at least one of said various types of illumination is in reflection from another of the separate zones, and
the device is configured so that a plurality of said various types of illumination of separate zones are in transmission through a plurality of separate zones and so that a plurality of said various types of illumination are in reflection from a plurality of other of the separate zones.

9. The device of claim 1, wherein the illuminating system and the camera are, in operation, stationary relative to one another, and the transparent substrate travels relative to the illuminating system and the camera.

10. The device of claim 1, further comprising a unit, which processes the images acquired by the camera, the processing unit comprising a computer and a memory in which processing programs are stored, which programs can be run by the computer, said programs being able to return quantities representative of the optical quality of the at least partially transparent substrate analyzed.

11. The device of claim 1, wherein at least one of the separate illumination zones has an oblong outline with a length/width ratio >10.

12. A method for analyzing the optical quality of an at least partially transparent substrate on a run, the method comprising:
forming an image in transmission through the at least partially transparent substrate and/or in reflection from the at least partially transparent substrate with an illuminating system;
acquiring the image transmitted and/or reflected by the at least partially transparent substrate with a camera; and
running programs controlling the acquisition of the images by the camera, wherein:
the illuminating system simultaneously produces illumination of different types in separate illumination zones through which the at least partially transparent substrate runs;
images are acquired simultaneously by a plurality of rows of pixels in a plurality of groups of adjacent rows of pixels, corresponding, respectively, to said separate illumination zones; and
the various acquisitions are synchronized with the run speed of the at least partially transparent substrate such that at least a given fixed point on the at least partially transparent substrate is the subject of an image acquired by a first of said groups of rows of pixels and, at least, of an image acquired by a second group that is different from the first.
